(19) United States
(12) Patent Application Publication
(10) Pub. No.: US 2011/0103998 A1
(43) Pub. Date: May 5, 2011

(54) Production of Nickel

(76) Inventors: Ivan Ratchev, New South Wales (AU); Grant Caffery, Western Australia (AU); Simon Philip Sullivan, Victoria (AU); René Ignacio Olivares, New South Wales (AU); Gregory David Rigby, New South Wales (AU)

(21) Appl. No.: 12/739,767

(22) PCT Filed: Oct. 24, 2008
(86) PCT No.: PCT/AU2008/001579

§ 371 Date: Nov. 30, 2010

(30) Foreign Application Priority Data
Oct. 26, 2007 (AU) 2007905891
Dec. 5, 2007 (AU) 2007906646

(51) Int. Cl. C22C 19/03; C01G 53/11; C09K 3/00; C22B 23/00

(52) U.S. Cl. 420/441; 423/561.1; 423/138; 252/182.33; 75/628

(57) ABSTRACT

A method of producing a nickel product (including nickel alloy products and products such as nickel matte) from a nickel intermediate product is disclosed. The method comprises smelting a dried nickel intermediate product in a molten bath-based smelter and forming a molten pool containing a molten metal and a slag, with the molten metal being the nickel product. Intermediate and end products produced by the method are also disclosed.

The present invention relates to the production of nickel.

The term “nickel” is understood herein to include nickel on its own, alloys such as ferronickels that contain nickel, and products such as nickel matte that also contain nickel.

Nickel is an important industrial metal and end-uses of the metal include stainless steels, high temperature alloys such as Inconel (Registered Trade Mark), and catalysts.

The present invention relates particularly to the production of nickel from a nickel intermediate product.

The term “nickel intermediate product” is understood herein to mean a nickel-containing product that is produced by hydrometallurgically processing a nickel-containing ore or a concentrate of the ore. The hydrometallurgical processing may include any one or more of atmospheric acid leaching, pressure acid leaching, and heap leaching under acidic conditions.

The nickel-containing ore may be any ore, such as an oxide ore (i.e. a laterite ore) or a sulphide ore.

Nickel intermediate products include, by way of example, nickel carbonates as produced by the Caron process at the Yabulu refinery of the applicant.

Nickel intermediate products also include, by way of example, nickel hydroxide products.

The present invention relates particularly, although by no means exclusively, to the production of nickel from a nickel intermediate product in the form of a nickel hydroxide product that is produced by hydrometallurgically processing a nickel-containing ore or a concentrate of the ore.

The term “nickel hydroxide product” is understood herein to mean any product that contains nickel hydroxide that is produced by hydrometallurgically processing a nickel-containing ore or a concentrate of the ore and includes products that also contain other compounds such as any one or more of iron hydroxides, magnesium sulphates, calcium sulphates, manganese oxides and/or hydroxides, cobalt hydroxides, alumina, silica, and sodium sulphates and trace amounts of other elements.

Typically, the nickel hydroxide product is in the form of a paste or a slurry with a water (i.e. moisture) content of 30-75 wt % (i.e. free water and bound water). In any given situation, the water content depends on a range of factors, including the particle size distribution of the solid components, the degree of mechanical filtration or de-watering, and evaporation.

The nickel hydroxide product may be produced by (a) any suitable hydrometallurgical process (such as pressure acid leaching, heap leaching under acidic conditions, and atmospheric acid leaching—or a combination) that brings nickel into an aqueous solution and (b) precipitating nickel hydroxide from solution for example using compounds such as MgO, CaO, CaCO₃, and Na₂CO₃.

One particular, although by no means the only, example of a hydrometallurgical process is a process that comprises extracting nickel and iron from an aqueous solution onto an ion exchange resin, stripping the nickel and iron from the resin with an acid and forming another aqueous solution, and then precipitating nickel and iron as a nickel iron hydroxide product.

International application PCT/AU2005/001360 (WO 2006/029443) in the name of the applicant describes and claims a process for the production of nickel in the form of a ferronickel or a nickel matte from an aqueous solution containing at least nickel, cobalt, iron, and impurities that comprises a series of steps including smelting a nickel intermediate product in the form of a nickel iron hydroxide product in an electric arc furnace.

Claim 1 of the International application defines the invention in the following terms:

“A process for the production of nickel in the form of a ferronickel or a nickel matte from a product liquor solution containing at least nickel, cobalt, iron and acid soluble impurities, said process including the steps of:

(a) contacting the product liquor solution containing the nickel, cobalt, iron and acid soluble impurities with an ion exchange resin, wherein the resin selectively absorbs nickel and iron from the solution leaving the cobalt and the acid soluble impurities in the raffinate;

(b) stripping the nickel and iron from the resin with a sulphuric acid solution to produce an eluate containing nickel and iron;

(c) neutralising the eluate to precipitate a mixed nickel iron hydroxide product; and

(d) reducing and smelting the mixed nickel iron hydroxide product to produce ferronickel or nickel matte.”

The applicant has carried out further research and development work in relation to smelting nickel intermediate products.

The above description is not to be taken as an admission of the common general knowledge in Australia or elsewhere.

In broad terms the present invention is a method of producing a nickel product (including nickel alloy products and products such as nickel matte) from a nickel intermediate product as described above that comprises smelting a dried nickel intermediate product in a molten bath-based smelter and forming a molten pool containing a molten metal and a slag, with the molten metal being the nickel product.

According to the present invention there is provided a method of producing a nickel product (including nickel alloy products and products such as nickel matte) from a nickel intermediate product as described above that comprises a step of smelting a dried form of the nickel intermediate product in a molten bath-based smelter and forming a molten pool containing a molten metal and a slag, with the molten metal comprising at least 95 wt. % of the nickel in the nickel intermediate product, and with the molten metal being the nickel product.

Preferably the method comprises a step of drying the nickel intermediate product prior to supplying the product to the smelter.

Preferably the drying step comprises drying the nickel intermediate product to at least substantially remove the free water in the nickel intermediate product supplied to the method.

The drying step is particularly important in a situation in which the nickel intermediate product supplied to the drying step is in the form of a paste

Typically, the drying step is carried out at a temperature of at least 100° C.

Typically, the drying step is carried out at a temperature of no more than 120° C.

Typically, the nickel intermediate product supplied to the drying step contains 25-50 wt. % nickel, on a dry basis determined after drying the product at 105° C.

Typically, the nickel intermediate product supplied to the drying step contains 30-75 wt. % free water and the product is in the form of a paste or a slurry.

The nickel intermediate product may be a nickel hydroxide product that is produced by hydrometallurgically processing a nickel-containing ore or a concentrate of the ore.

The nickel hydroxide product may be an iron-containing nickel hydroxide product.

The iron-containing nickel hydroxide product may have a high concentration of iron, i.e. at least 3 wt. % iron.

Typically, the molten metal comprises at least 98 wt. % of the nickel in the nickel intermediate product.

Preferably the molten metal comprises at least 99 wt. % of the nickel in the nickel intermediate product.

Preferably the smelting step comprises selecting smelting conditions that maximise the amount of nickel in the molten metal and minimise the amount of nickel in the slag and the amount of nickel in an off-gas generated in the smelting step. As is indicated above, this is a particularly important step given the high cost of nickel and the high cost of removing nickel in downstream processing of slag and dust.

Preferably the smelting step comprises adding fluxes to promote the formation of molten slag that comprises elements in the nickel intermediate product that are regarded as contaminants in the nickel product. One suitable flux is lime.

Preferably the smelting step comprises selecting smelting conditions to promote the formation of molten slag that comprises elements in the nickel intermediate product that are regarded as contaminants in the nickel product.

The term “contaminants” is understood herein to include any one or more of magnesium, calcium, cobalt, copper, manganese, silicon, and aluminium in elemental form and oxide form.

Preferably the smelting step comprises using a carbonaceous material as a source of reductant for smelting the dried nickel hydroxide product.

Preferably the carbonaceous material is a solid carbonaceous material, typically char, coke, or coal.

Preferably the smelting step comprises smelting the dried nickel intermediate product under conditions that generate minimal dust.

Preferably the smelting step comprises treating an off-gas produced in the smelting step and removing nickel from the off-gas.

Typically, the smelting step is carried out in an electric arc furnace or another molten bath-based smelter. The electric arc furnace may be an ac or a dc furnace. Other molten bath-based smelters include induction furnaces and sulphide smelters such as flash smelters.

Preferably the method comprises treating the dried nickel intermediate product to remove bound water, i.e. water of crystallisation, from the product and producing a treated product that becomes a feed material for the smelting step.

Preferably the bound water treatment step comprises calcining the dried nickel intermediate product at a temperature of at least 400° C.

More preferably the bound water treatment step comprises calcining the dried nickel intermediate product at a temperature of at least 600° C.

Typically, the bound water treatment step comprises calcining the dried nickel intermediate product at a temperature of at least 900° C.

The calcining step to remove bound water may be carried out under oxidising conditions or reducing conditions.

The drying step and the calcining step may be carried out in effect as a single step with a drying stage and a calcining stage or as separate drying and calcining steps.

In situations where the nickel intermediate product contains sulphur in amounts that may be an issue in the nickel product, preferably the method comprises treating the dried nickel intermediate product from the drying step to remove sulphur from the product and producing a treated product that becomes a feed material for the smelting step.

The bound water treatment step and the sulphur treatment step may be carried out as a single step or as separate steps.

Preferably the sulphur treatment step at least substantially removes sulphur from the dried nickel intermediate product from the drying step.

Preferably the sulphur treatment step comprises calcining the dried nickel intermediate product from the drying step under oxidising conditions at a temperature in a range of 800-1300° C.

Preferably the calcining step at least substantially removes sulphur from the dried nickel intermediate product from the drying step as SO₂ and SO₂ gas.

Typically, the calcining step is carried out in a calciner and the oxidising conditions are produced by supplying air or an oxygen-enriched air to the calciner.

The calcining step may be carried out in any suitable calciner, such as a flash calciner, a kiln, a multi-hearth furnace, a fluidised bed, and a shaft furnace.

The method may further comprise a step of selecting or controlling the particle size of the nickel intermediate product to be suitable for the smelting step.

Depending on the circumstances, for example on the type of smelter and the composition of the nickel intermediate product, the nickel intermediate product may be in the form of fines and/or larger particles.

The method may comprise agglomerating the nickel intermediate product to form a suitable particle size for the smelting step.

The drying step and/or the calcining step may result in required agglomeration of the nickel intermediate product.

The method may further comprise a step of refining the molten metal from the smelting step to tailor the composition of the nickel product to suit an end-use application of the product, such as an element in a composition of a stainless steel.

Typically, the refining step includes at least partially removing any one or more of carbon, silicon and sulphur from the molten metal from the smelting step.

According to the present invention there is also provided a nickel product produced by the above-described method.

By way of example, the nickel product may be a ferronickel product or a nickel matte, i.e. a nickel sulphide product.

According to the present invention there is provided a calcined nickel intermediate product produced in the calcining step in the above-described method, the calcined nickel intermediate product comprising at least 70 wt. % nickel as nickel oxide.

According to the present invention there is provided a molten slag produced in the smelting step in the above-described method, the molten slag comprising less than 1.0 wt. %, more preferably less that 0.5 wt. %, of the nickel in the nickel intermediate product supplied to the drying step.

According to the present invention there is provided a molten metal produced in the smelting step in the above-described method, the molten metal comprising at least 95 wt. %, more preferably at least 99 wt. %, of the nickel in the nickel intermediate product supplied to the drying step.

The present invention is described further by way of example with reference to the accompanying drawings, of which:

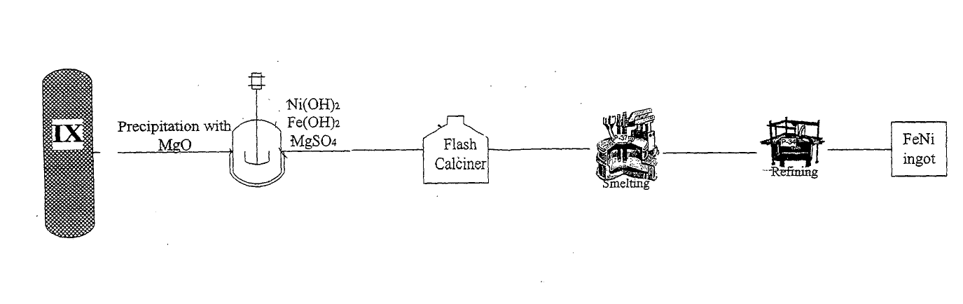

FIG. 1 is a diagram that summarises one embodiment of the method of the present invention;

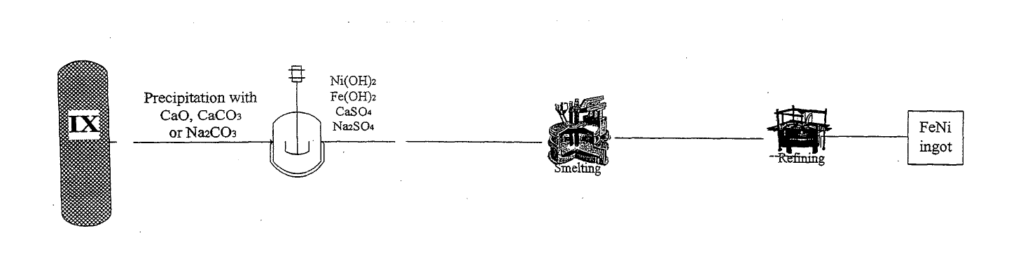

FIG. 2 is a diagram that summarises another embodiment of the method of the present invention;

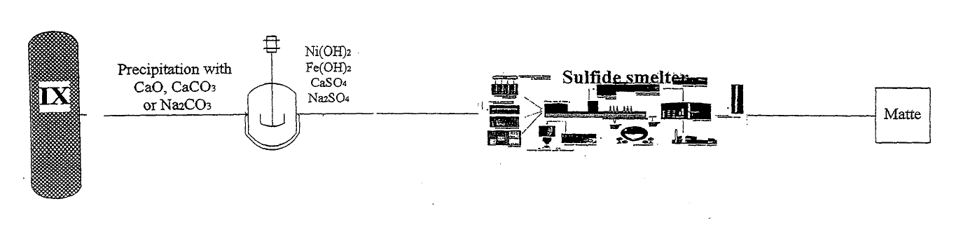

FIG. 3 is a diagram that summarises another embodiment of the method of the present invention; and

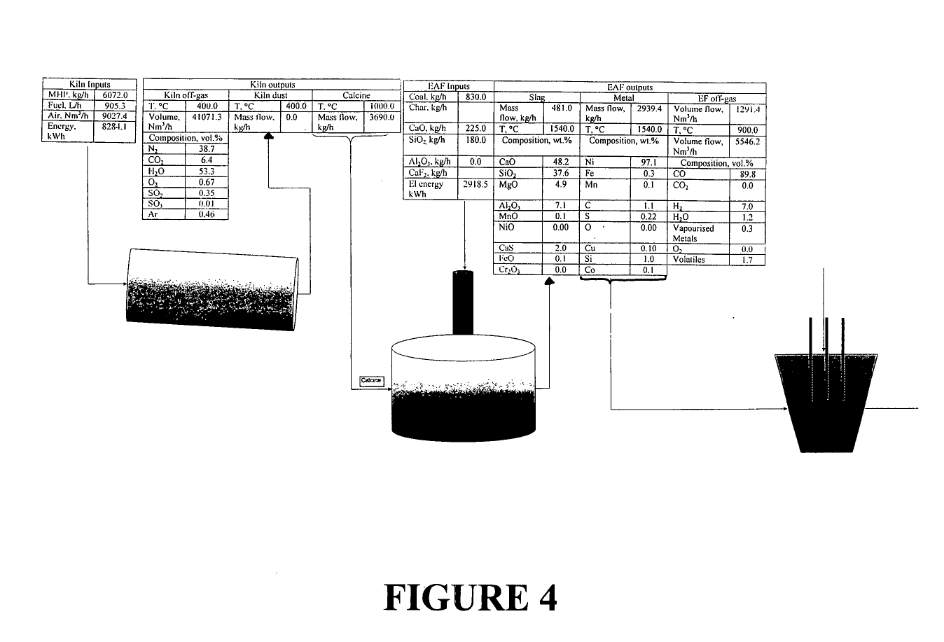

FIGS. 4-7 summarise the results of 4 different runs of a model of the embodiment of the method of the present invention.

The method shown in FIG. 1 comprises a series of steps that process a feed material comprising a nickel intermediate product that is formed by using MgO to precipitate the nickel intermediate product from a solution derived from an ion exchange treatment of a leach liquor containing nickel, iron, and other elements in solution. The nickel intermediate product comprises nickel hydroxide, iron hydroxide and magnesium sulphate. The nickel intermediate product is in the form of a paste and contains significant amounts of free and bound water. The method steps comprise a first step of drying and calcining the nickel intermediate product in a diesel-fired or gas-fired kiln or other suitable calciner (or combination of kilns and calciners) to completely remove water (free water and bound water) and sulphur from the product. The calcination temperature is selected to be 1000° C. Typically, after drying to remove free water, the dried nickel intermediate product is introduced into the calciner with the calciner at a lower temperature, such as in a range of 350-450° C. and the temperature is ramped up over time to the temperature of 1000° C. The next step in the method comprises smelting the dried and calcined product in an EAF (or other suitable molten bath-based smelter) using coal (or other suitable carbonaceous material) as a reductant and adding slag-forming fluxes (such as lime) and producing molten slag and molten metal in the EAF. The fluxes and the EAF operating conditions are targeted to: (i) maximise nickel in the molten metal and minimise nickel in the molten slag and an off-gas from the EAF, (ii) maximise sulphur in the molten slag, (iii) maximise magnesium in the molten slag, and (iv) provide the molten metal with selected concentrations of carbon, sulphur, silicon and manganese. The smelting step may be operated on a continuous or a batch basis. The next step in the method comprises refining the molten metal to tailor the composition of the nickel product to suit an end-use application of the product, such as an element in a composition of a stainless steel. Typically, the refining step includes at least partially removing any one or more of carbon, silicon and sulphur from the molten metal. The refined metal is cast into suitably sized ingots for transport and end-use applications.

The method may be carried out on one site and be a part of a more extensive method that comprises a combination of hydrometallurgical and pyrometallurgical steps that process mined ore and produce a nickel product. International application PCT/AU2005/001360 (WO 2006/029443) mentioned above is an example of such a process.

Alternatively, the method may be carried out on a number of different sites. For example, the nickel intermediate product in the form of a paste may be produced on one site and transported as a paste and processed in a calciner and a smelter to produce a nickel product at another site.

By way of further example, the nickel intermediate paste may be dried (to at least remove free water) on one site and transported dry to another site and calcined and smelted at the other site to produce a nickel product.

The method illustrated in FIG. 2 is very similar to that shown in FIG. 1. One difference is the feed materials. In the FIG. 1 method, the nickel intermediate product is formed by using MgO to precipitate the nickel intermediate product from solution. In the FIG. 2 method precipitation of the nickel intermediate product is achieved by using any one or more of calcium carbonate, calcium oxide, and sodium carbonate and the resultant intermediate nickel product comprises nickel hydroxide, iron hydroxide, calcium sulphate, and sodium sulphate. The FIG. 2 method is suitable for nickel intermediate products that have low sulphur contents, i.e. sulphur contents less than 1% by weight. Such low sulphur feeds can be processed in smelters and, hence, calcination at high temperatures, say at least 800° C. may not be necessary.

With reference to FIG. 3, the method shown in the Figure is the same as the FIG. 2 method in that the nickel intermediate product is precipitated by using any one or more of calcium carbonate, calcium oxide, and sodium carbonate. However, the FIG. 2 method applies in situations where the nickel intermediate has higher sulphur contents, i.e. sulphur contents greater than 1% by weight, that can not be accommodated well in molten bath-based smelters. As a consequence, the method includes processing the dried nickel intermediate product in a sulphide smelter, such as the flash smelter operating at Kalgoorlie, Western Australia and producing a matte.

The outcomes of the methods described in FIGS. 2 and 3 demonstrate a finding by the applicant that satisfactory removal of sulphur in the calcining step depends on the type of precipitation agent used. In the method of FIG. 2, the formation of stable compounds of calcium and sulphur (e.g. CaSO₄) inhibits sulphur removal at calcining temperatures up to 1000° C. Conversely, for Ni intermediates formed using the method of FIG. 1, the compounds of magnesium and sulphur are more easily decomposed during calcining at temperatures below 1000° C., thereby facilitating greater levels of sulphur removal.

As mentioned above, the applicant has developed a model to evaluate the method of the invention. The model is based on a series of heat and mass balances with thermodynamic inputs.

The applicant based the model on and ran the model using the following information:
Production of 25,000 tonnes of nickel per year.
Two different nickel intermediate products in the form of nickel iron hydroxide products having the compositions set out below, with each product being modelled with two different moisture contents, namely 40 wt. % and 70 wt. %.
The method for each nickel iron hydroxide product comprising the steps of: (a) drying and calcining the product in a diesel-fired or gas-fired kiln operating at 400° C. and a calciner operating at 1000° C. to completely remove water (free water and water of crystallisation) and sulphur from the product (b) smelting the dried and calcined product in an EAF using coal as a reductant and adding slag-forming fluxes and producing molten slag and molten metal in the EAF, with the fluxes and the EAF operating conditions being targeted to: (i) maximise nickel in the molten metal and minimise nickel in the molten slag and an off-gas from the EAF, (ii) maximise sulphur in the molten slag, (iii) maximise magnesium, calcium, and sodium in the molten slag, and (iv) provide the molten metal with selected concentrations of carbon, sulphur, silicon and manganese.
One of the two nickel iron hydroxide products modelled was produced by a heap leach/ion exchange process—with the following elements and compounds in wt. %, determined on a dry basis at 105° C., set out in Table 1 below.

TABLE 1

| Elemental | Wt. % | Compound | wt. % |
|---|---|---|---|
| Al | 0.05 | MgSO₄ | 0.77 |
| Ca | 0.20 | Ca₂SO₄*2H₂O | 0.86 |
| Cl | 0.20 | MgSO₄*7H₂O | 35.62 |
| Co | 0.10 | Al [OH] ₃ | 0.14 |
| Cu | 0.05 | Co [OH] ₂ | 0.16 |
| Fe | 3.00 | Cu [OH] ₂ | 0.08 |
| Mg | 4.00 | FeO*OH | 4.77 |
| Mn | 0.10 | Mg [OH] ₂ | 0.66 |
| Na | 0.02 | Mn [OH] ₂ | 0.16 |
| Ni | 35.00 | Ni [OH] ₂ | 55.28 |
| S | 5.00 | Zn [OH] ₂ | 1.22 |
| Zn | 0.80 | MgCl₂ | 0.23 |
| | | NaCl | 0.05 |

The other of the two nickel iron hydroxide products modelled was produced by a soda ash process—with the following elements and compounds in wt. %, determined on a dry basis at 105° C., set out in Table 2 below.

TABLE 2

| Elemental | Wt. % | Compound | wt. % |
|---|---|---|---|
| Ca | 0.10 | CaSO₄*2H₂O | 0.43 |
| Cl | 0.10 | MgSO₄*7H₂O | 1.01 |
| Co | 0.05 | Na₂SO₄*10H₂O | 0.25 |
| Cu | 0.05 | NiSO₄*6H₂O | 10.32 |
| Fe | 0.10 | ZnSO₄*7H₂O | 0.04 |
| Mg | 0.10 | Co [OH] ₂ | 0.08 |
| Mn | 0.05 | Cu [OH] ₂ | 0.08 |
| Na | 0.10 | FeO*OH | 0.16 |
| Ni | 47.00 | Mn [OH] ₂ | 0.08 |
| S | 1.50 | Ni [OH] ₂ | 70.60 |
| Zn | 0.01 | NaCl | 0.16 |

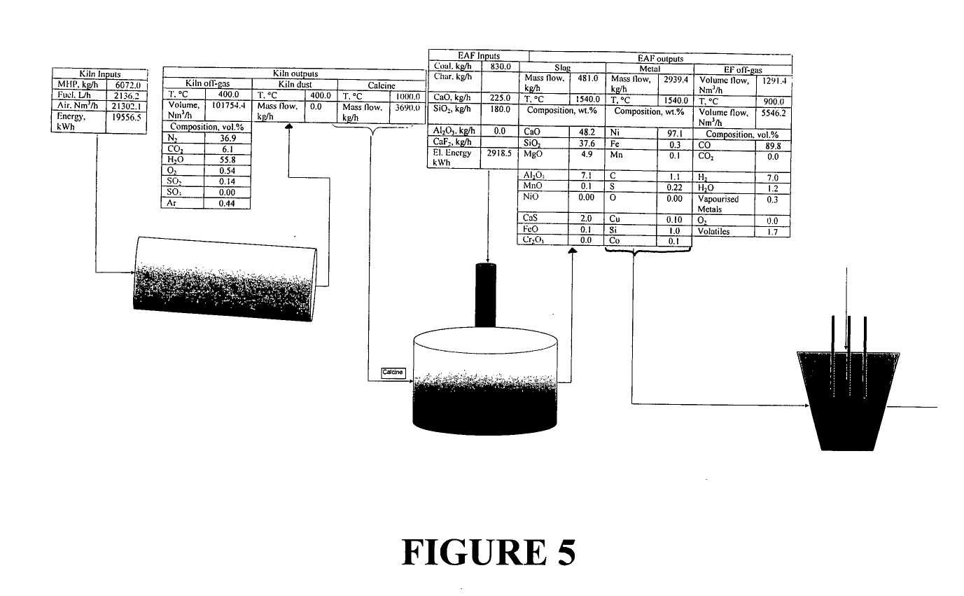

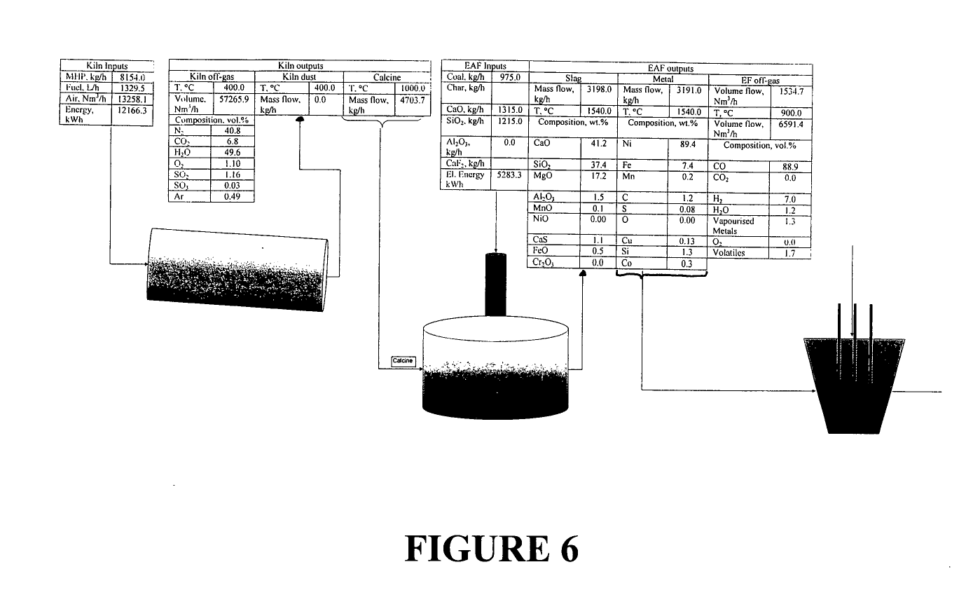

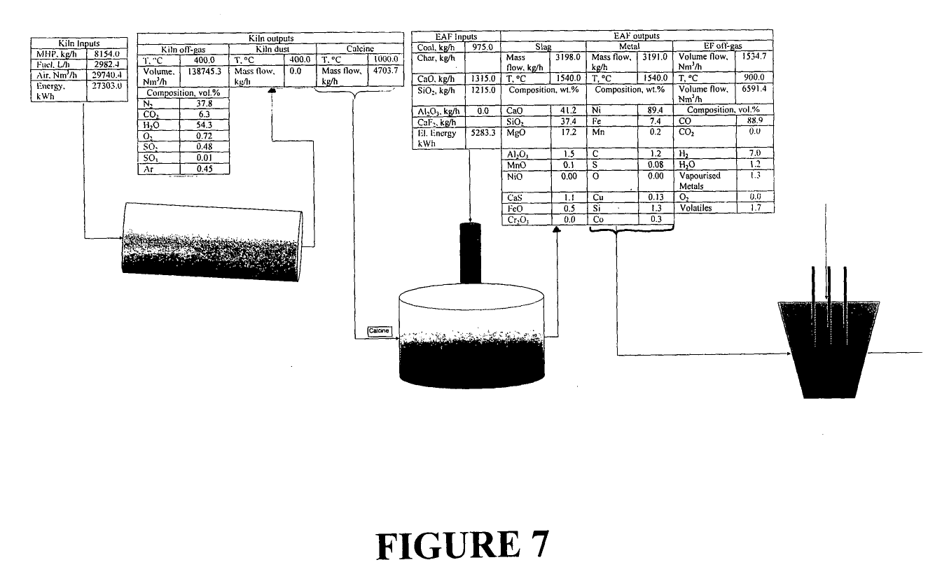

FIGS. 4-7 summarise the compositions of the inputs and outputs to the kiln and the EAF as predicted by the models for the two nickel hydroxide products at the different moisture contents of 40 wt. % and 70 wt. %. FIG. 4 relates to the composition in Table 2 at 40% moisture, FIG. 5 relates to the composition in Table 2 at 70% moisture, FIG. 6 relates to the composition in Table 1 at 40% moisture, and FIG. 7 relates to the composition in Table 2 at 70% moisture.

The modelling work found that there were substantial differences between the amounts of energy required to dry and calcine and then smelt the nickel hydroxide products. Energy requirements are a major consideration for a commercially viable method. Specifically, the models calculated the following energy requirements:
FIG. 4 run (Table 2, 40%)—14.1 GJ/tonne of nickel;
FIG. 5 run (Table 2, 70%)—28.4 GJ/tonne of nickel;
FIG. 6 run (Table 1, 40%)—22.0 GJ/tonne of nickel;
FIG. 7 run (Table 1, 70%)—41.1 GJ/tonne of nickel.

It is evident from the inputs and outputs reported in FIGS. 4-7 and the modelling work generally that the amount of water and the amount of “contaminants”, such as magnesium and silicon, in the nickel hydroxide products had a major impact on the amount of energy required to produce the target nickel products (i.e. in terms of compositions of the products and maximum recovery of nickel to the products) in each run. In this context, it is relevant to note that there are substantial differences in the compositions of the two nickel hydroxide products that were modelled. Specifically, the Table 1 product had much higher concentrations of iron, magnesium, manganese, silicon, sulphur, etc than the Table 2 product.

In overall terms, the modelling work indicates that there is considerable scope with the method of the present invention to process nickel hydroxide products having significant variations in composition and water content and produce nickel products having a wide range of compositions tailored to the requirements of end-use applications.

Many modifications may be made to the method of the present invention summarised in the Figures without departing from the spirit and scope of the present invention.

By way of example, the embodiments of the method shown in FIGS. 1-3 are not the only possible embodiments and the method of the invention may comprise different combinations of steps carried out on different feed materials.

By way of further example, whilst the above-mentioned modelling work was based on nickel intermediate products in the form of nickel iron hydroxide products, the present invention is not so limited and extends processing any suitable nickel intermediate products, such as nickel carbonates mentioned above, of any composition and moisture content.

In addition, whilst the above-mentioned modelling work was based on nickel intermediate products in the form of nickel iron hydroxide products having particular compositions and moisture contents, the present invention is not so limited and extends to processing nickel iron hydroxide products of any composition and moisture content.

1-22. (canceled)

23. A method of producing a nickel product from a nickel intermediate product that comprises a step of smelting a dried form of the nickel intermediate product in a molten bath-based smelter and forming a molten pool containing a molten metal and a slag, with the molten metal comprising at least about 95 wt. % of the nickel in the nickel intermediate product, and with the molten metal being the nickel product.

24. The method defined in claim 23 further comprising a step of drying the nickel intermediate product prior to supplying the product to the smelter.

25. The method defined in claim 24 wherein the drying step comprises drying the nickel intermediate product to at least substantially remove free water in the nickel intermediate product supplied to the method.

26. The method defined in claim 24 wherein the nickel intermediate product supplied to the drying step contains about 25-50 wt. % nickel, on a dry basis determined after drying the product at about 105° C.

27. The method defined in claim 24 wherein the nickel intermediate product supplied to the drying step contains about 30-75 wt. % free water and is in the form of a paste or a slurry.

28. The method defined in claim 23 wherein the nickel intermediate product is a nickel hydroxide product that is produced by hydrometallurgically processing a nickel-containing ore or a concentrate of the ore.

29. The method defined in claim 23 wherein the smelting step produces molten metal comprising at least about 98 wt. % of the nickel in the nickel intermediate product.

30. The method defined in claim 23 wherein the smelting step comprises selecting smelting conditions that maximise the amount of nickel in the molten metal and minimise the amount of nickel in the slag and the amount of nickel in an off-gas generated in the smelting step.

31. The method defined in claim 23 wherein the smelting step comprises adding fluxes to promote the formation of molten slag that comprises elements in the nickel intermediate product that are regarded as contaminants in the nickel product.

32. The method defined in claim 23 wherein the smelting step comprises selecting smelting conditions to promote the formation of molten slag that comprises elements in the nickel intermediate product that are regarded as contaminants in the nickel product.

33. The method defined in claim 23 wherein the smelting step comprises using a carbonaceous material as a source of reductant for smelting the dried nickel intermediate product.

34. The method defined in claim 33 wherein the carbonaceous material is a solid carbonaceous material.

35. The method defined in claim 23 wherein the smelting step comprises treating an off-gas produced in the smelting step and removing nickel from the off-gas.

36. The method defined in claim 23 further comprising treating the dried nickel intermediate product to remove bound water to produce a treated product that becomes a feed material for the smelting step.

37. The method defined in claim 36 wherein the bound water treatment step comprises calcining the dried nickel intermediate product at a temperature of at least 400° C.

38. The method defined in claim 36 further comprising drying the nickel intermediate product prior to supplying the product to the smelter wherein the drying step and the calcining step are carried out as a single step with a drying stage and a calcining stage or as separate drying and calcining steps.

39. The method defined in claim 23 further comprising treating the dried nickel intermediate product to remove sulphur from the product and producing a treated product that becomes a feed material for the smelting step.

40. The method defined in claim 23 further comprising refining the molten metal from the smelting step to tailor the composition of the nickel product to suit an end-use application of the product.

41. A nickel product produced by the method defined in claim 23.

42. A calcined nickel intermediate product produced in the calcining step defined in claim 37 and comprising at least about 70 wt. % nickel as nickel oxide.

43. A molten slag produced in the smelting step in the method defined in claim 23, the molten slag comprising less than about 1.0 wt. % of the nickel in the nickel intermediate product supplied to the drying step.

44. A molten metal produced in the smelting step in the method defined in claim 23, the molten metal comprising at least about 95 wt. % of the nickel in the nickel intermediate product supplied to the drying step.
